(19) United States
(12) Patent Application Publication
(10) Pub. No.: US 2017/0091539 A1
(43) Pub. Date: Mar. 30, 2017

(54) ID Information for Identifying an Animal

(71) Applicant: Scanimal Trackers Limited, Chippenham Wiltshire (GB)

(72) Inventors: Alexander Lawrence Shipp, Chippenham Wiltshire (GB); Stewart Neil Everett, Chippenham Wiltshire (GB)

(21) Appl. No.: 15/312,547

(22) PCT Filed: May 19, 2015
(86) PCT No.: PCT/GB2015/051461

§ 371 Date: Nov. 18, 2016

(30) Foreign Application Priority Data
May 20, 2014 (GB) 1408948.6

(51) Int. Cl. G06K 9/00; A01K 11/00; A01K 29/00; G06F 17/30

(52) U.S. Cl. CPC G06K 9/00362; G06F 17/30259; A01K 11/006; A01K 29/00; G06F 17/3028

(57) ABSTRACT

ID information that identifies an animal is generated from an image of the animal. A reference outline of a view of the animal is provided and the animal is aligned with the outline, either by changing the field of view of during image capture or by scaling and/or shifting either automatically or on the basis of user-input. The image is then analyzed to detect markings of the animal and ID information is generated that comprises marking data representing the nature of the detected markings, including the position of the detected markings with respect to the outline, and the size and shape of the markings. A linguistic representation of the ID information is also generated. The ID information in respect of the animal is stored in a database.

### FIELD

The present invention relates to the generation of ID information that identifies an animal.

### BACKGROUND

Mankind rears large numbers of animals and the maintenance of records in respect of such animals is desirable for many reasons, relating to ownership and health amongst other things. It is therefore desirable to generate and store ID information in respect of animals that identifies them.

By way of example, horses are one type of animal where records are important due to the value of individual animals. Currently, records of horses are typically maintained in “horse passports”, as follows.

Currently, horse passports are paper based. They have the facility to contain photographs of the horse, but these are difficult to keep up to date, and difficult to keep to a standard format. Indeed, there are many types of horse passport maintained by different authorities. The passport may have a template where markings can be filled in by hand and where descriptions of the markings can be entered, but this is still subject to the problem of inconsistent data entry. Different people will record the same markings of the horse in different terms. There are standard descriptions to use for various types of marking, which can be filled in incorrectly. Also, when put to the test, many people even have problem with left and right and enter the description on the wrong side of the horse.

There is an additional issue that the markings may change with time. Many breeds of horse change color and marking gradually, either year by year or with the change of seasons. This can result in the pictures and descriptions quickly becoming out of date. As it is difficult to change the pictures, they are therefore often out of date. Even where the underlying markings do not themselves change, the hair length, for example of the winter coat, may affect the visibility of the design. In such a case, the visual appearance of the horse will change even if the underlying markings remain.

Rather than keeping the pictures on a paper document, it may be considered to store records in computer storage, for example in an online database. This will make it much easier to update the records than a paper passport. More than one generation of pictures may be stored, so that the history of how the horse looks over its life can be recorded.

There remains the issue of how to generate ID information that identifies an animal in a reliable and consistent manner, for use in records making use of computer storage.

### SUMMARY

According the a first aspect of the present invention, there is provided a method of generating ID information that identifies an animal from an image of the animal, the method comprising computer-implemented steps of: analyzing the image to detect markings of the animal; and generating ID information comprising marking data representing the nature of the detected markings.

Thus, the marking data representing the nature of markings of the animal may be generated automatically in a computer, based on an analysis of an image of the animal to detect the markings. This provides for consistent recognition of the markings which increases the reliability of the ID information. This provides significant advantage in use, increasing the likelihood that ID information will actually match the animal.

Furthermore, the ID information may be generated at successive times, and includes date data indicating the time that the image was captured. That allows for generating and storage of historical ID information. This increases the likelihood that it is possible to cover the current condition of the horse at any given time in the stored ID information.

Dating of the ID information may be used to provide the ability to automatically prompt for updates. This can be at regular intervals, so that if the image is older than a certain date the owner is prompted to either submit new image or verify that a previous image is still current. The frequency of updates can be tailored to the breed of animal, if known. If the breed is known to change color during its lifetime then prompts can be sent at suitable intervals. If the breed is known to change color by seasons, then different pictures can be maintained by season, and the owner prompted to verify images each season. This can be improved if the location of the animal is known, because this will allow the season at that location to be determined.

The present invention may be applied to in the case that the animal is a horse. However, the present invention is not restricted to this, and may be applied to any other non-human animal.

The marking data can include the color or colors of the overall animal and its markings. Coat colors such as appaloosa, bay, brindle, dun, pinto or roan can be identified.

The method may further comprise generating a linguistic representation of the ID information. This presents the ID information in a form that is more readily understood, and may be consistent with existing linguistic descriptions of markings of the animal. The markings can be identified using standard terminology.

Some non-exhaustive examples in the case of a horse include bald face, snip, strip, star, and blaze (nose). Other markings include whorls, socks, stockings, fetlock, pastern, coronet, ermine marks. Scars and brands can also be identified.

The image may be one that is captured at the same time as the analysis steps, as part of the overall method. Alternatively, the image may be one that was captured earlier.

Advantageously, the marking data represents the position of the detected markings on the animal. The marking data may further represent the size and/or shape of the detected markings.

The owner can nominate other parties to maintain the photographs and verify details and receive prompts if appropriate.

Various steps of the method may be implemented in a computer apparatus.

Thus, according to another aspect of the present invention, there is provided a computer apparatus configured to perform a method similar to the first aspect of the invention.

Similarly, according to another aspect of the present invention, there is provided a computer program capable of execution by a computer apparatus, the computer program being configured to perform, on execution, a method similar to the first aspect of the invention. The computer program may be stored on a computer-readable storage medium.

In general, the computer apparatus may be of any type. In one example, the computer-implemented steps of analyzing the image to detect markings of the animal and generating ID information are performed in an apparatus that also comprises the image-capture device and optionally also a display, for example a mobile telephone or a tablet which allow applications to control the camera.

The method can also be adapted to other technologies. For example, the image may be captured by a separate camera apparatus having an image capture device, for example a conventional digital camera, and then transferred to a computer apparatus for analysis. The transfer may be a direct transfer to a locally provided the computer apparatus, such as a laptop, tablet, desktop computer, or may be a transfer over a network, such as Wi-Fi or the interne, to a remote computer apparatus, such as a server, e.g. in the cloud. In the latter case, the remote computer apparatus may be associated with an online database storing records for many animals.

The image and generated ID information may be stored together with additional information such as the date of image capture, the season, if appropriate, and the name and status of the person who uploaded it.

Similarly, non-digital photographs can be scanned into a computer apparatus to create the image which is then handled in the same manner as a captured image.

Similarly, the method may be performed in a distributed manner in which different steps of the method are performed in different computer apparatuses.

Advantageously, the method may further comprise, before the step of analyzing the image: providing a reference outline of a view of the animal; and aligning the animal in the image with the outline. In that case, the generated ID information may represent the position of the detected markings with respect to the outline. This technique improves the ability to identify markings in a consistent manner by increasing the uniformity of the images being analyzed and allowing detection of markings to occur with respect to the outline. Accordingly, this improves the consistent recognition of the markings, thereby further increasing the reliability of the ID information.

Various methods for performing the alignment of the animal with the outline are possible. Some non-limitative examples are as follows.

The alignment may be performed by displaying the image and displaying the reference outline as an overlay on the displayed image, and then shifting and/or scaling the image relative to the outline on the basis of user-input. In this case, the alignment is performed under the control of the user.

The alignment may be performed by computer-implemented steps of: detecting the animal in the image; and shifting and/or scaling the image relative to the outline to align the detected animal with the outline. In this case, the alignment is performed automatically, which may provide for more accurate alignment, subject to the implementation.

Another example relates to the case that the computer-implemented steps of analyzing the image to detect markings of the animal and generating ID information are performed in an apparatus comprising an image-capture device and a display arranged to display the image captured by the image capture device. In this case, the reference outline may be displayed as an overlay on the displayed image captured by the image capture device; and alignment may be performed by the user changing the field of view of the image capture device. In this manner, the alignment is performed under the control of the user at the time of image capture.

The ID information may further comprise size data representing at least one size measurement of the animal.

Currently, the standard linguistic descriptions for horses do not contain accurate measurements. For instance, a typical description for a marking on a horse might be “whorl above upper eye level to left of midline”. In accordance with the present method, the provision of size data allows the ID information to better identify the animal.

The size data may include a measurement of the size of one or more features of the animal. This size data may be input by a user, or may be calculated from the image. Thus, in the case that user-input is accepted indicating at least one first size measurement, then at least one second size measurement relative to the at least one first size measurement may be derived by analyzing the image.

In the case of a horse, usually only one size measurement is taken, namely the height. This is measured from the ground to the top of the highest non-variable point of the skeleton, the withers. This is often measured in hands, a hand being equivalent to 4 inches. Although measurements between whole hands are usually expressed in what appears to be decimal format, the subdivision of the hand is not decimal but is in base 4, so subdivisions after the radix point are in quarters of a hand, which are inches. Thus, 62 inches is fifteen and a half hands, or 15.2 hh (normally said as “fifteen-two”, or occasionally in full as “fifteen hands two inches). Some countries use the metric system instead of hands.

The height of a horse is therefore not always recorded with much accuracy, and of course can vary depending how the horse is shod. There are competition standards for measuring, but these would not be enforced for the general horse population. The net result is that the height of the horse on a given date may be known, but it may not very accurate. A 14 hands horse (56 inches) measured to an accuracy of say 1 inch has error of about 2% associated with that measurement.

To deal with issues of this type, a known size measurement can be mapped onto the images of the animal, and from that, all other size measurements extrapolated. This step may be performed subject to the dates of the images less than a threshold. This step may be done on a per-image basis, as for each individual image may or may not have enough reference points to make the calculation. Some images will show the height of the animal, and this will then allow mapping to take place easily. Other images, such as head shots, will not. For these, common elements from other images can be identified. For instance, the size of the head will be known from the side shot of the animal, where the height is also known. This can then be mapped over to the image of the head only. Each time this occurs, accuracy will be lost.

When this can be done, this will give actual values, rather than fractional offsets, for all other size measurements. This will of course, have an associated degree of accuracy, which can be estimated and recorded.

The position of the markings indicated by the marking data may be represented relative to one or more of the size measurements represented by the size data. This allows the position of the markings to be quantified, thereby providing information on the position of the markings with far greater detail than is provided by current standard descriptions.

As the exact size of the animal might not be known, the position of the markings can be recorded in relative terms. Measurements could be made in various different ways. One such way would be to record the leftmost and rightmost part of the animal in the image, and record horizontal distances as a fraction of that amount starting from the left. Similarly vertical distances are measured as a fraction of the amount between the top and bottom of the animal in the image, starting from the bottom. An example of the resultant ID information for a marking might be “whorl on head. Ref image #72. Bottom 0.75, top 0.76, left 0.55, right 0.56”

It may be that the accuracy of the image recognition algorithms improves over time. Thus, the version of the algorithm used should also be recorded.

In addition to the standard descriptive elements used to describe a horse, new size measurements can be added that would not have been useful before, but can now be used to aid recognition. These could for instance include: width of head; height of head; distance between eyes; distance between ears; height of ears; distance between nostrils; distance between nostrils and eyes (left and right) and/or distance between eyes and ears (left and right). Such size measurements may be recorded as fractional distances, relative to the width and height of the head and/or actual distances, as detailed before.

### BRIEF DESCRIPTION OF THE DRAWINGS

Some embodiments of the present invention and examples of images will now be described by way of non-limitative example with reference to the accompanying drawings, in which:

FIG. 1 is a schematic view of a computer apparatus;

FIG. 2 is a flow chart of a method performed in the computer apparatus;

FIG. 3 is a view of the image displayed on a display of the computer apparatus;

FIG. 4 is a collection of reference outlines for different views of a horse;

FIGS. 5 to 7 are images of the head of an actual horse showing stages of image analysis;

FIG. 8 is an outline of the head of the horse showing the marking identified in the image of FIG. 5;

FIG. 9 is a view of the outline of a horse showing size measurements that may be taken;

FIG. 10 shows the outline of the head of a horse showing some specific size measurements;

FIG. 11 shows the outline of the head of the horse shown in FIG. 10 with some information on the size and position of the marking;

FIG. 12 is an example of a images of a horse with particular markings, each aligned with one of the reference outlines of FIG. 4;

FIG. 13 is a linguistic representation of the ID information of the horse of FIG. 12; and

FIG. 14 is a flowchart of a searching method.

### DETAILED DESCRIPTION

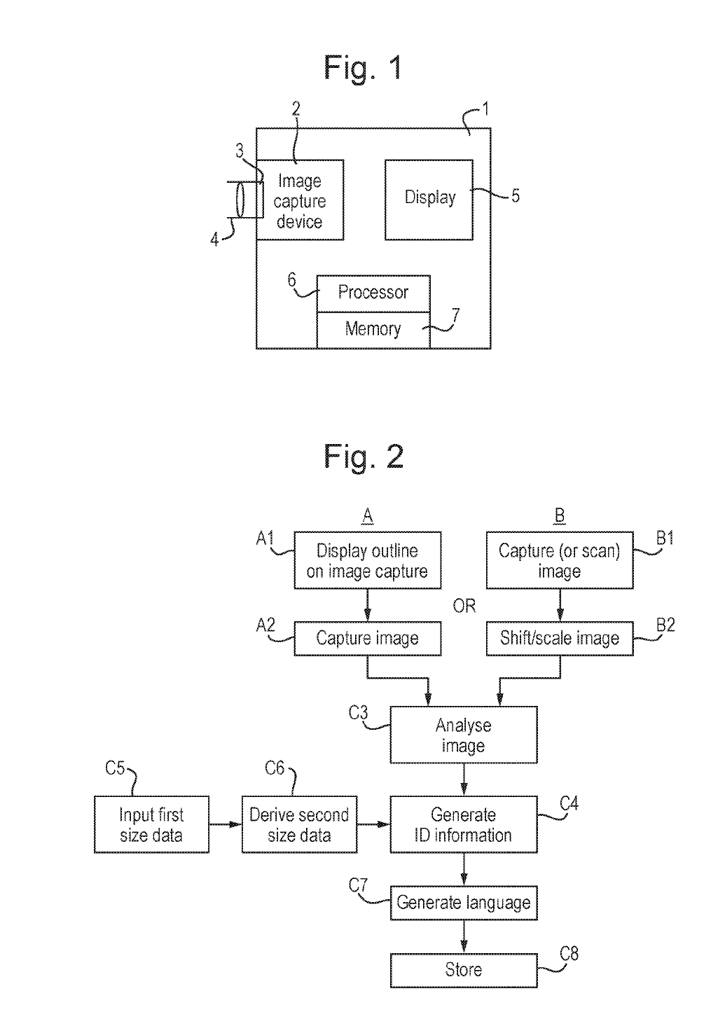

FIG. 1 illustrates a computer apparatus 1 in which a method of generating ID information (identity information) may be implemented. The computer apparatus 1 may have a conventional construction, and may be for example a mobile telephone or a tablet.

The computer apparatus 1 includes an image capture device 2 that may have a conventional construction for capturing images, typically including an image sensor 3, for example a CMOS image sensor, for sensing an image and an optical system 4 for focusing the image on the image sensor 3.

The computer apparatus 1 also includes a display 5 configured to display images. The display 5 may be operated to display, as well as images stored in the computer apparatus 1, the image currently captured by the image capture device 3, so that the display acts as a view finder.

The computer apparatus 1 also includes a processor 6 and a memory 7. The processor 6 may execute computer programs that may be stored in the memory 7. Under the control of a computer program, the processor 6 may control the operation of the computer apparatus 1.

More generally, the computer apparatus 1 may be any type of computer apparatus including a conventional personal computer or a server. The computer program may be written in any suitable programming language. The computer program may be stored on a computer-readable storage medium, which may be of any type, for example: a recording medium which is insertable into a drive of the computing apparatus 1 and which may store information magnetically, optically or opto-magnetically; a fixed recording medium of the computer system such as a hard drive; or a computer memory, the memory 7 being an example of this in the case of the computer apparatus 1 of FIG. 1.

FIG. 2 illustrates a method of generating ID information that identifies an animal, that may be performed in the computer apparatus by a computer program. For the sake of illustration, the animal is a horse in this example, but the method may be applied to any animal. The method may further incorporate the various features described above in general terms.

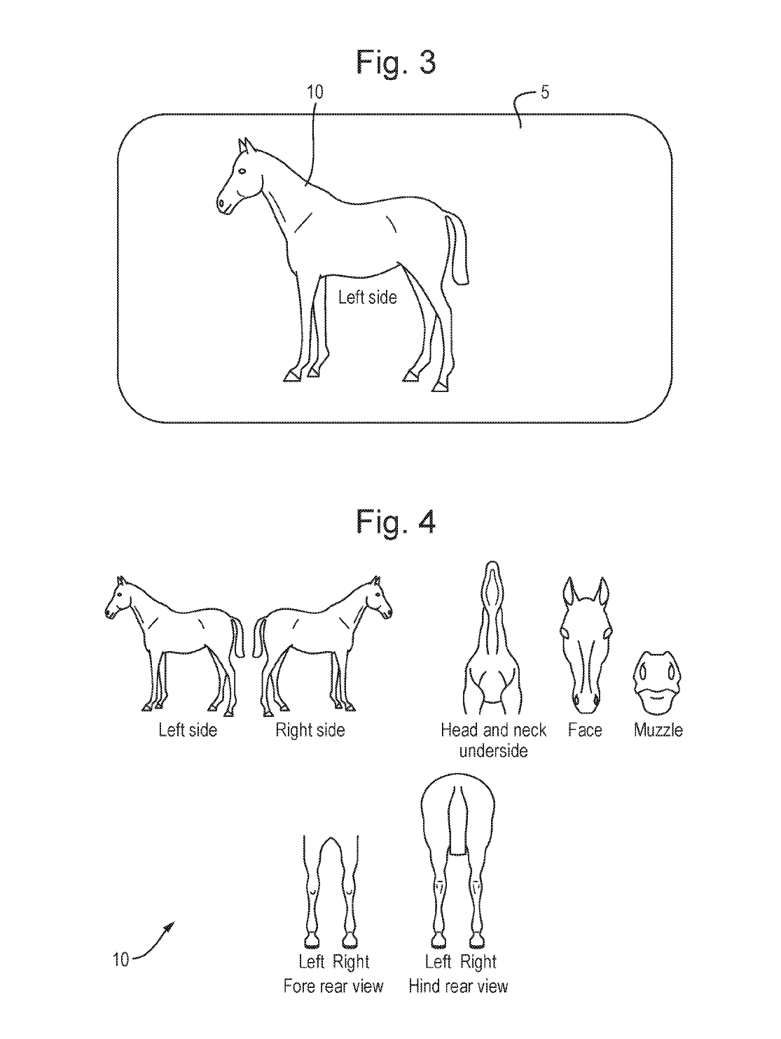

The method has two alternative initial stages A or B which each use a reference outline of a view of the animal and result in the provision of an image of an animal in which the animal is aligned with the reference outline. By way of example FIG. 3 illustrates such a reference outline 10 displayed on the display 5. In this example, the reference outline 10 is the left side of the overall horse. More generally it is possible to use plural different outlines of the horse. FIG. 4 illustrates a set of such reference outlines 10.

In initial stage A, the alignment is performed under the control of the user at the time of image capture, as follows.

In step A1, the image capture device 2 is operated and the image captured by the image capture device 2 is being displayed on the display 5 as shown in FIG. 3. At the same time, the reference outline 10 is displayed on the display 5 as an overlay on the displayed image captured by the image capture device 2. The user then changes the field of view of the image capture device 2 to align the animal in the image with the reference outline 10. The field of view is changed in a conventional manner by changing the pan, zoom and tilt (PZT) of the image capture device 2.

Once the user alignment has achieved alignment of the animal in the image and the reference outline 10, in step A2, the user operates the image capture device 2 to capture the image.

In initial stage B, the alignment is performed on an image after it has been captured, as follows.

In step B1, the image is captured by the image capture device 2. As an alternative in step B1, where the image is available as a hard copy, that hard copy may be scanned and transferred to the computer apparatus 1. In either case, the image is stored in the memory 7.

In step B2, the image is shifted and/or scaled relative to the reference outline 10 to align the animal in the image with the reference outline 10. There are two alternatives for this step.

In the first alternative of step B2, the image is displayed on the display 5 and the reference outline 10 is also displayed on the display 5 as an overlay on the displayed image as shown in FIG. 3. Then, the shifting and/or scaling of the image relative to the reference outline 10 is performed on the basis of user-input. In this case, the user controls and selects the alignment.

In the second alternative of step B2, shifting and/or scaling is performed by the computer apparatus 1. That is, the computer apparatus 1 detects the animal in the image using image processing techniques and then performs shifting and/or scaling of the image relative to the reference outline 10 perform the alignment.

After either of initial stages A or B, steps C3 to C8 are then performed using the image in which the animal has been aligned with the outline, as follows.

In step C3, the image is analyzed to detect markings of the animal.

Step C3 may be performed entirely by the computer apparatus 1 performing a graphical analysis of the image.

Alternatively in step C3, user-input may also be used to improve the step of analysis of analyzing the image. For example, the method may allow a user to provide user-input that selects a standard animal marking, such as a flash, then use user-input device, such as a mouse or touch screen, to identify this on the image.

That process based on user-input may use graphical analysis to help the user. For example, the method may allow a user to select just one position in the marking and the computer apparatus 1 may then use image processing techniques to identify areas of similar color to suggest the boundaries of the marking. The person can also draw a rough line around the boundary and the processing can then suggest a better outline. Graphical tools can be used to fine tune the boundary, moving it slightly here and there, stretching and shrinking as necessary.

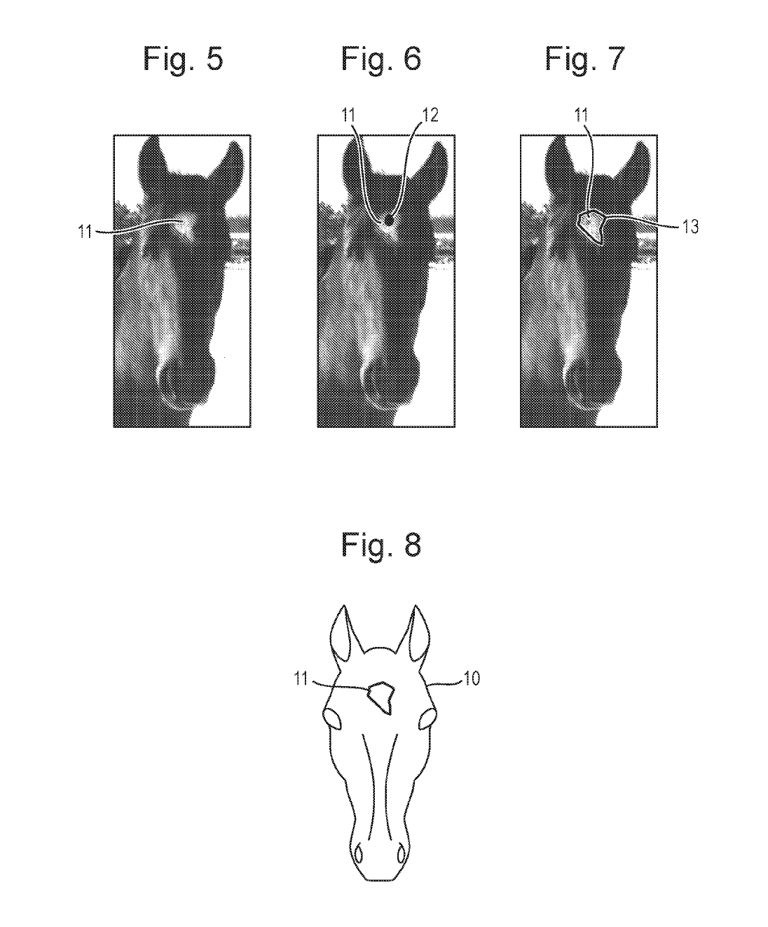

FIGS. 5 to 8 illustrate the processing with respect to an image of the head of an actual horse. FIG. 5 shows the original image. As can be seen, the horse has a marking in the form of a star 11 on its forehead. FIG. 6 shows the identification of a point 12 in the star 11 by the user. FIG. 7 shows the results of the image processing in identifying the outline 13 of the star 11. FIG. 8 is the corresponding reference outline 10 of the head of the horse showing the star 11 identified relative to that reference outline 10.

In step C4, there is generated ID information. The ID information comprises marking data representing the nature of the markings detected in step C3. The ID information represents the position of the detected markings with respect to the reference outline 10, and may further represent the size and/or shape of the detected markings on the animal.

The marking data may also represent the color of the animal and its markings, as discussed above.

Furthermore, the ID information also comprises date data indicating the time that the image was captured.

In step C5, there is accepted user-input that indicates at least one first size measurement of the animal. This may be any size measurement of the animal for example height or any of the other size measurements discussed above.

By way of example,

In step C6, the image is analyzed to derive at least one second size measurement relative to the at least one first size measurement.

Based on the output of steps C5 and C6, the ID information generated in step C4 also comprises size data representing the first and second size measurements of the animal. In addition, the marking data represents the position of the detected markings on the animal relative to a size measurement represented by the size data.

More generally, the size information may take the form, and may be generated, in accordance with the general description given above.

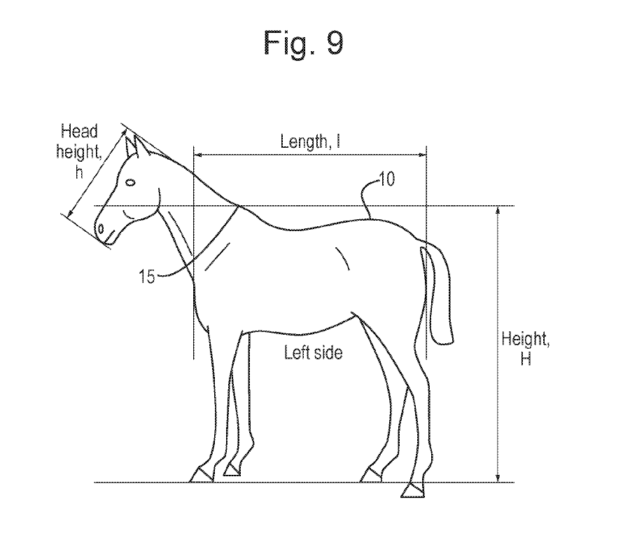

FIG. 9 is a view of the reference outline 10 of a horse showing some possible size measurements that may be used. Although the reference outline 10 is shown for ease of explanation, the actual size measurements will be input by the user or derived from analysis of images as discussed above. FIG. 9 shows in particular the following size measurements: height, measured to the top of the withers 15; length; and head height. In the case that the height is first size information input by the user, then the length and head height may be second size information that is derived relative to the height. For example, taking the height as H, then based on the image analysis of a given horse, the length l may be 1.2 H and the head height h may be 0.4H. Thus, if the actual height of the horse input by the user is 14 hands then the length will be 67.2 inches and the head height will be 22.4 inches. As there is a degree of inaccuracy involved, the measurements may be rounded off when displayed, and an indication of accuracy given.

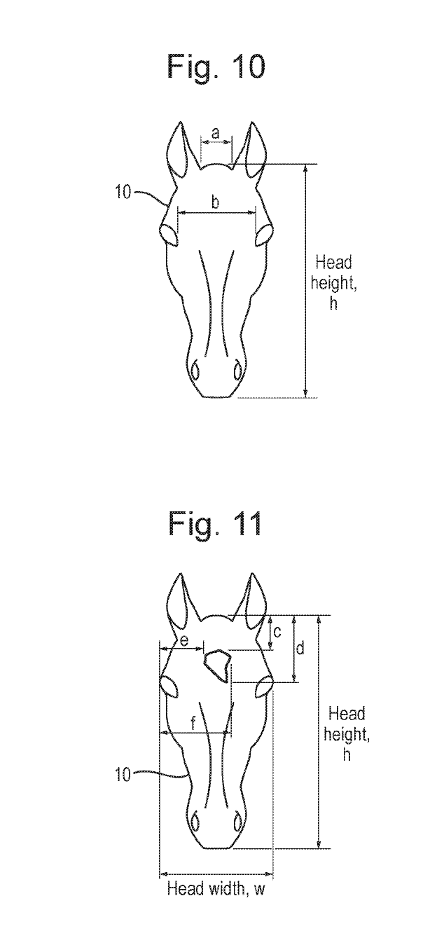

Similarly, FIG. 10 shows the shows the reference outline 10 of the head of a horse to illustrate some specific size measurements on the head. Again, although the reference outline 10 is shown for ease of explanation, the actual size measurements will be input by the user or derived from analysis of images as discussed above. From this view, the

head height h together with other measurements such as distance a between the ears and the distance b between the eyes. For example, taking the head height as h, then based on the image analysis of a given horse, the distance a between the ears may be 0.1 h and the distance b between the eyes may be 0.4 h. Thus, if the actual head height of the horse is 22.4 inches then distance a between the ears will be 2.24 inches and the distance b between the eyes will be 6.72 inches.

FIG. 11 shows the reference outline 10 of the head of the horse shown in FIG. 8 to illustrate how the marking data may represent the position of the star 11 relative to the size measurements. Again, although the reference outline 10 is shown for ease of explanation, the position is based on the actual size measurements that are input by the user or derived from analysis of images as discussed above. In particular, FIG. 11 shows the size measurements of the head height h and the head width w. The following distances representing the position of the star 11 are also shown: the distance c from the top of the head to the top of the star 11; the distance; the distance d from the top of the head to the bottom of the star 11; the distance e from the left of the head to the left of the star 11; and the distance f from the left of the head to the right of the star 11. Based on these size measurements and distances, the position and size of the star 11 may be further given as follows: (h−d) is the relative distance from the bottom of the head to the bottom of the star 11; (w−f) is the relative distance from the right of the head to the right of the star; (d−c) is the relative height of the star 11; and (f−e) is the relative width of the star 11. If any one of these measurements is known, which could be the head height h as previously shown, the rest can be calculated.

In step C7, there is generated a linguistic representation of the ID information. This is also stored in the memory 7.

For example, in the case of the horse shown in FIG. 5, the descriptive text generated in respect of the star 11 may read: “Large irregular star in center of forehead. Bottom of star just below upper eye level.”

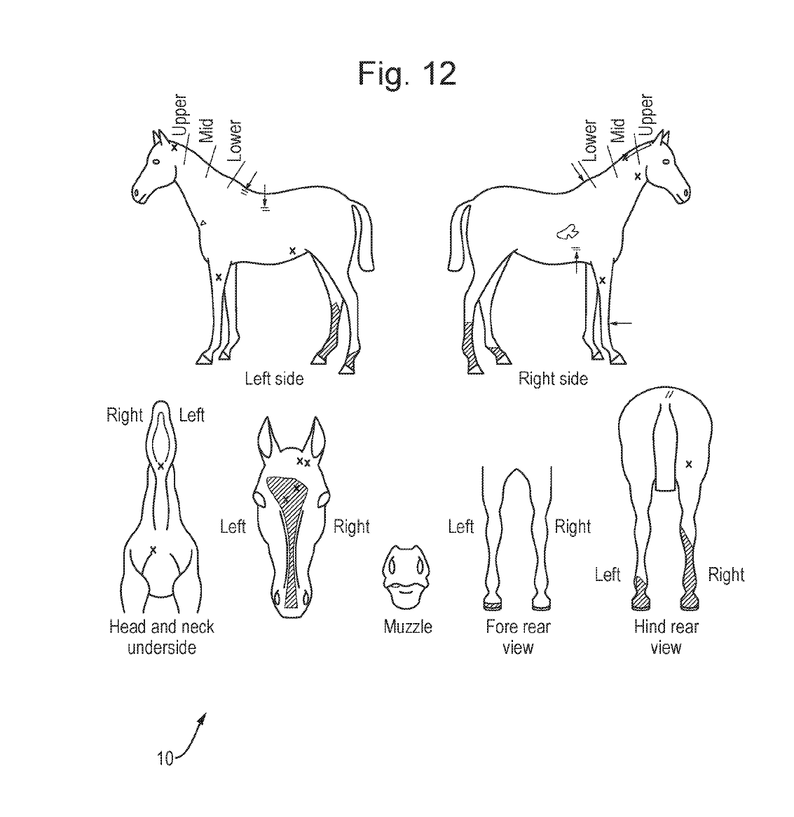

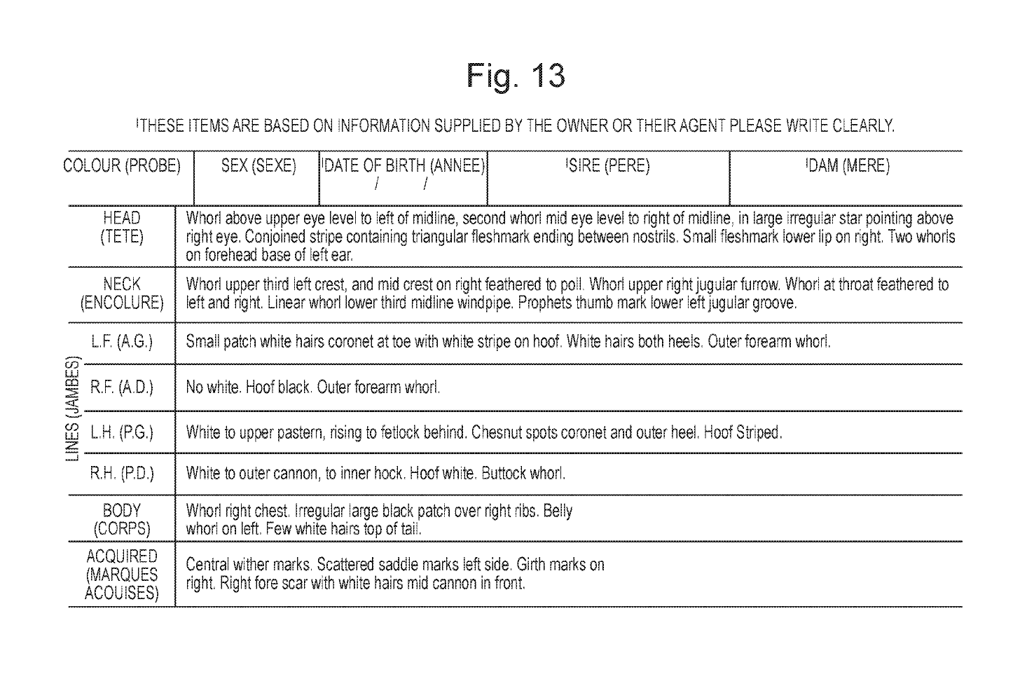

By way of further example, FIG. 12 illustrates images of a horse with particular markings aligned with each of the reference outlines shown in FIG. 4, and FIG. 13 is a table of linguistic representation of the ID information of the horse of FIG. 5 which describes the various markings represented by the ID information in words.

In step C8, the ID information in respect of the animal is stored in the memory 7 and on a database, for example an online database to which the ID information is uploaded.

The method may be repeated with different images of the same animal aligned to the different reference outlines 10 to provide more complete information representing the markings in different views of the animal.

The method may similarly be repeated at successive times in respect of the same animal, thereby generating and historical ID information allowing coverage of the appearance of the animal at different times and in different seasons.

Records generated using the present method may be stored in respect of multiple animals in the database. Once the database is sufficiently populated, the database may then be searched. This may be done, for example in respect of an unknown animal, for instance by law enforcement when a lost or stolen animal is recovered.

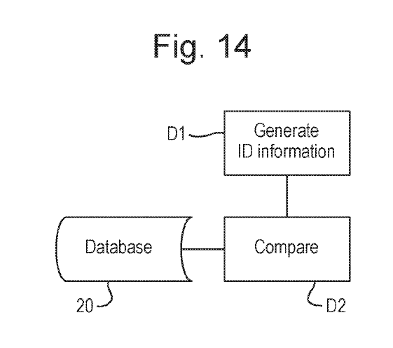

FIG. 14 shows an example of such a searching method performed with respect to a database 20 storing ID information comprising marking data representing the nature of markings of multiple animals, the ID information having been previously generated and stored using the method described above. The searching method shown in FIG. 14 may be performed on the computer apparatus 1, or may alternatively be performed on a different computer apparatus, for example a server associated with the database 20.

In step D1, ID information in respect of the unknown animal is generated on the basis of a captured image of the unknown animal using the method described above. In step D2, the ID information generated in step D1 is compared with the ID information stored in the database 20 to detect a match.

The comparison may output a list of possible matches, allowing the unknown animal to be reunited with its owner.

The comparison in step D2 may use any of the ID information and may use a variety of comparison criteria. Plural matches can be ranked in order of likelihood, using criteria such as closeness of match, distance between current location of the animal and last known location, whether the animal is reported lost or not, and how old the pictures are.

Matches can be made in various ways and marking data in respect of different markings may be given different weightings. More obvious markings, such as a blaze on the forehead or stockings on the legs can be given higher weighting. If a blaze is present on an animal in one image but not another, they are likely to be different animals.

For example, if a whorl is present on the image of one animal but not another, then this might just be that the whorl is difficult to detect and so was simply not recorded by analyzing one image even though it was there. To counter this, the matching system may allow manually entered markings so that if image recognition misses something, this can be manually added. The matching system will mark these as manually added along with the identity of the person adding them. The system will also allow deletion of markings which are not really there but are artefacts of image processing. In these cases the information will not be actually deleted, but will be marked as deleted along with the identity of the person deleting them. The system may restrict changes to certain classes of people, such as the owner, vets and law enforcement.

If a marking is present on both animals, then the closer the match for position and size, the more likely it is to be the same animal. Where possible, the same image recognition algorithms should be used on both sets of pictures. If they are different, then a more accurate comparison may be made by running the newer image recognition software over the stored pictures to recalculate.

The more matches on the more markings there are, the more likely it is that the two animals are the same.

To speed comparison, large numbers of animals may be excluded if the height, main color or breed are obviously different.

If no close matches are found, it may be that the animal is not present in the database. It may also be a clue that the animal has been disguised. If the actual animal is available, this can be checked for. Otherwise, matches can be attempted by ignoring some markings, such as color, and concentrating on others which are difficult to disguise, such as whorls or scars.

To counter fraud, where some people may erroneously manually add or delete markings, the match can ignore all manual changes.

A confidence rating system can be created, where some people are more trusted than others to make changes. Matches can be made with manual changes over a certain confidence level added.

Although a method has been described above that is performed in the computer apparatus 1 shown in FIG. 1, in general the method can be applied to images acquired in any manner. Similarly the method may be equally be performed in a server to which the image is transmitted. Thus, the method may be performed before or after online storage of the image. Equally processing may take place on a different computer apparatus from that which captured the image, such as a tablet, laptop or desktop computer. Processing may be shared in any amount from 0-100% with cloud computer technology, so that the more limited a device's power and capability, the more cloud computing can be used.

1. A method of generating ID information that identifies an animal from an image of the animal, the method comprising computer-implemented steps of:
analyzing the image to detect markings of the animal; and
generating ID information comprising marking data representing the nature of the detected markings.

2. A method according to claim 1, further comprising generating a linguistic representation of the ID information.

3. A method according to claim 1, wherein the marking data represents the position of the detected markings on the animal.

4. A method according to claim 3, wherein the marking data further represents the size of the detected markings.

5. A method according to claim 3, wherein the marking data represents the shape of the detected markings.

6. A method according to claim 1, wherein the animal is a horse.

7. A method according to claim 1, wherein the ID information further comprises size data representing at least one size measurement of the animal.

8. A method according to claim 7, further comprising:
accepting user-input indicating at least one first size measurement; and
analyzing the image to derive at least one second size measurement relative to the at least one first size measurement,
the size data representing the at least one first size measurement and the at least one second size measurement.

9. A method according to claim 7, wherein the marking data represents the position of the detected markings on the animal relative to a size measurement represented by the size data.

10. A method according to claim 1, further comprising storing the generated ID information in a database.

11. A method according to claim 1, further comprising comparing the generated ID information with ID information comprising marking data representing the nature of markings of animals stored in a database to detect a match.

12. A method according to claim 1, further comprising, before the step of analyzing the image:
providing a reference outline of a view of the animal; and
aligning the animal in the image with the outline,
wherein the marking data represents the position of the detected markings with respect to the outline.

13. A method according to claim 10, wherein the step of aligning the animal in the image with the outline comprises computer-implemented steps of:
displaying the image and displaying the reference outline as an overlay on the displayed image; and
shifting and/or scaling the image relative to the outline on the basis of user-input.

14. A method according to claim 10, wherein the step of aligning the animal in the image with the outline comprises computer-implemented steps of:
detecting the animal in the image; and
shifting and/or scaling the image relative to the outline to align the detected animal with the outline.

15. A method according to claim 10, wherein:
the computer-implemented steps of analyzing the image to detect markings of the animal and generating ID information are performed in an apparatus comprising an image-capture device and a display arranged to display the image captured by the image capture device;
the step of providing a reference outline of a view of the animal comprises a computer-implemented step of displaying the reference outline as an overlay on the displayed image captured by the image capture device; and
the step of aligning the animal in the image with the outline is performed by the user changing the field of view of the image capture device.

16. A method according to claim 1, further comprising capturing the image in an image capture device.

17. A method according to claim 16, wherein the computer-implemented steps of analyzing the image to detect markings of the animal and generating ID information are performed in an apparatus comprising the image-capture device.

18. A computer program capable of execution by a computer apparatus, the computer program being configured to perform, on execution, a method according to claim 1.

19. A computer-readable storage medium storing a computer program according to claim 1.

20. A computer apparatus configured to perform a method according to claim 1.
